(19) United States
(12) Patent Application Publication
(10) Pub. No.: US 2013/0173439 A1
(43) Pub. Date: Jul. 4, 2013

(54) System and Method for Remote Veterinary Image Analysis and Consultation

(71) Applicant: Kevin Christiansen, Overland Park, KS (US)

(72) Inventor: Kevin Christiansen, Overland Park, KS (US)

(73) Assignee: VOGAL, LLC, Overland Park, KS (US)

(21) Appl. No.: 13/343,476

(22) Filed: Jan. 4, 2012

(51) Int. Cl. G06F 17/30; G06Q 30/04

(52) U.S. Cl. 705/34; 707/705; 707/E17.008

(57) ABSTRACT

A system and method for facilitating an exchange of information between a general practitioner (GP) veterinarian and a veterinarian specialist. The system may comprise a computing device with a processor, memory, a display, and a user interface. The GP veterinarian may use the computing device to locate an appropriate veterinarian specialist and to send and receive files to and from the veterinarian specialist. One method of the present invention may comprise receiving a file containing medical information corresponding a patient or animal, permitting the veterinarian specialist to annotate the file, and sending the file with annotations from the veterinarian specialist to the GP veterinarian so that the GP veterinarian can use the file with the annotations to treat the patient.

### BACKGROUND

1. Field

The present invention relates to a system and method for facilitating exchange of diagnostic information between a general practitioner veterinarian and a veterinarian specialist.

2. Related Art

Veterinary professionals may be generalists or specialists. Typically, a general practitioner (GP) veterinarian is the primary care giver for a broad range of animals with a broad range of medical issues. However, when a GP veterinarian realizes that a particular animal or a particular medical issue is beyond his or her expertise, the GP veterinarian may need to refer the animal to a veterinarian specialist or consult with a veterinarian specialist to make an appropriate diagnosis. Locating the appropriate veterinarian specialist may involve searching various physical and online directories, as well as contacting one or more of the veterinarian specialists by phone to determine the cost of such a consult.

If the veterinarian specialist is not located geographically close to the patient, it may not be possible or cost-effective for the patient to be seen by the veterinarian specialist in a timely fashion. In this situation, the GP veterinarian may have to mail, fax, or email medical information, such as test results and diagnostic images, for review by the veterinarian specialist. Then the veterinarian specialist must communicate a diagnosis and/or recommendations to the GP veterinarian, generally by phone, mail, or email. This may involve printing and/or annotating a physical copy of diagnostic images or graphs by hand with a pen or pencil, then mailing the annotated image back to the GP veterinarian. Once such services are rendered, the veterinarian specialist typically submits an invoice to the GP veterinarian by mail. These steps can be time consuming and slow, and the delays can jeopardize the patient's health.

### SUMMARY

Embodiments of the present invention provide a system, computer program and method for facilitating the exchange of diagnostic information between a general practitioner (GP) veterinarian and a veterinarian specialist. An embodiment of the computer program may run on a computing device operated by the veterinarian specialist and may comprise a code segment for receiving a file comprising medical information corresponding to a patient of the GP veterinarian and a code segment for permitting the veterinarian specialist to annotate the file. The computer program may further comprise a code segment for sending the file with annotations from the veterinarian specialist to the GP veterinarian so that the GP veterinarian can use the annotated file to treat the patient.

In another embodiment of the invention, the computer program may run on a computing device operated by the GP veterinarian and may comprise a code segment for receiving a file comprising medical information corresponding to a patient of a GP veterinarian and a code segment for identifying a veterinarian specialist from a database of a plurality of veterinarian specialists based on input from the GP veterinarian. Additionally, the computer program may comprise a code segment for sending the file to the veterinarian specialist and a code segment for receiving information from the veterinarian specialist regarding a review of the file by the veterinarian specialist.

In yet another embodiment of the invention, the computer program may be configured to run on the computing device operated by the veterinarian specialist may comprise a code segment for receiving a file comprising medical information corresponding to a patient of a GP veterinarian and a code segment for annotating the file according to input or selections made by the veterinarian specialist. The computer program may further comprise a code segment for associating a supplemental file with the file and a code segment for sending the file with annotations and the supplemental file from the veterinarian specialist to the GP veterinarian. The supplemental file may include additional medical information related to the file, a medical diagnosis, and/or an invoice.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### DESCRIPTION OF DRAWING FIGURES

Embodiments of the present invention are described in detail below with reference to the attached drawing figures, wherein:

FIG. 1 is a is a schematic diagram of exemplary computer and communications equipment that may be used to implement embodiments of the invention;

FIG. 2 is a block diagram of components of a computing device that may be used to implement embodiments of the present invention;

FIG. 3 is a flow chart of a method of facilitating exchange of diagnostic information between a general practitioner (GP) veterinarian and a veterinarian specialist according to an embodiment of the present invention;

FIG. 4 is a flow chart of method of facilitating exchange of diagnostic information between a GP veterinarian and a veterinarian specialist according to another embodiment of the present invention;

FIG. 5 is a main menu that may be displayed on the computing device of FIG. 2;

FIG. 6 is a case menu that may be displayed on the computing device of FIG. 2 and illustrates several selectable case files;

FIG. 7 is a new case menu on that may be displayed on the computing device of FIG. 2 and illustrates several selectable options when creating a new case file;

FIG. 8 is a patient list that may be displayed on the computing device of FIG. 2 and illustrates a selectable list of patients;

FIG. 9 depicts several fillable text boxes that may be displayed on the computing device of FIG. 2 for entering notes regarding a case;

FIG. 10 is a patient profile that may be displayed on the computing device of FIG. 2;

FIG. 11 is an image menu that may be displayed on the computing device of FIG. 2 and illustrates several selectable image options;

FIG. 12 is an image capture page that may be displayed on the computing device of FIG. 2 and illustrates several selectable options for taking a digital photo with the computing device;

FIG. 13 illustrates an image captured with the computing device of FIG. 2 and illustrates several selectable options that may be displayed on the computing device of FIG. 2 along with the captured image for using or retaking the displayed image;

FIG. 14 depicts several fillable text boxes that may be displayed on the computing device of FIG. 2 for entering notes regarding the patient or the photo;

FIG. 15 is a submit page that may be displayed on the computing device of FIG. 2 for reviewing the case file and illustrates a selectable button for submitting the case file to a veterinarian specialist;

FIG. 16 is an alternative main menu that may be displayed on the computing device of FIG. 2, including selectable cases received from general practitioner (GP) veterinarians;

FIG. 17 is a patient file that may be displayed on the computing device of FIG. 2 and illustrates an overview of images received from an GP veterinarian and a notes section to be filled out by a veterinarian specialist;

FIG. 18 depicts drawing tools that may be displayed on the computing device of FIG. 2 to be used on or applied to any of the displayed images;

FIG. 19 depicts a fillable text box and an interactive keyboard that may be displayed on the computing device of FIG. 2, such that the veterinarian specialist may enter findings and recommendations regarding one of the cases;

FIG. 20 is a schematic view of an X-ray of a patient's spine and heart and illustrates the application of the drawing tools of FIG. 18 onto the X-ray image;

FIG. 21 is a schematic view of an X-ray of a patient's teeth and illustrates the application of free-hand drawing tools that may be displayed on the computing device of FIG. 2 to annotate the X-ray image;

FIG. 22 is an electrocardiogram (ECG) graph annotated by a veterinarian specialist using drawing tools that may be displayed on the computing device of FIG. 2;

FIG. 23 is another ECG graph annotated by a veterinarian specialist using drawing tools that may be displayed on the computing device of FIG. 2;

FIG. 24 is a schematic view of an X-ray of a broken limb annotated to illustrate where to apply various rods and pins to set the broken limb;

FIG. 25 is a schematic view of the X-ray of the broken limb of FIG. 24 with the rods and pins applied as annotated in FIG. 24; and

FIG. 26 is an image of a patient's test results including free-hand annotation added to draw attention to a particular one of the test results and a comments section which may be filled out by a veterinarian specialist.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

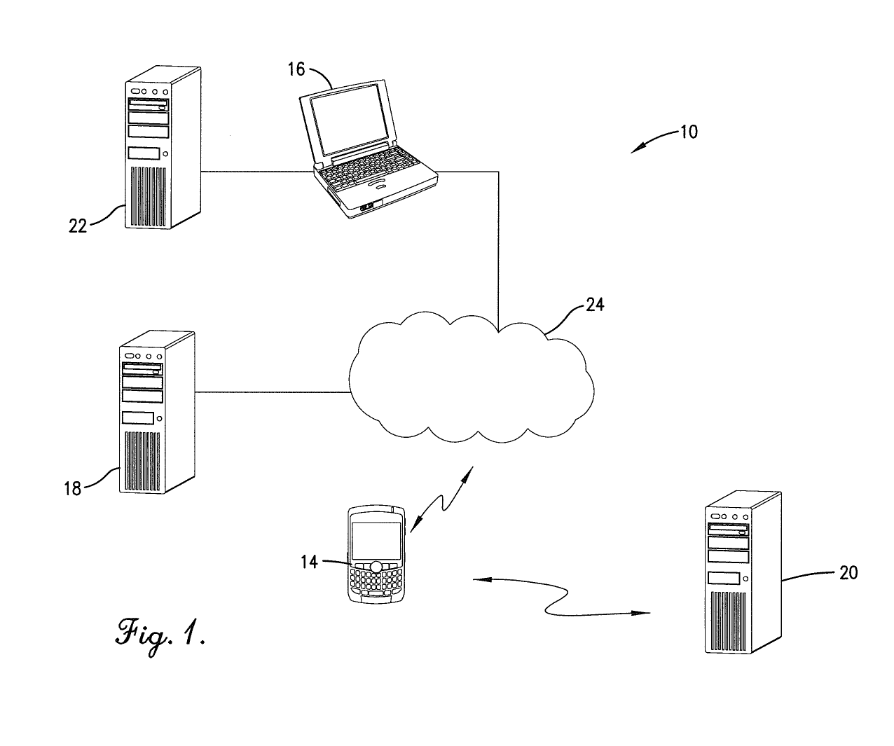

Aspects of the invention can be implemented with computer hardware, software, firmware, or a combination thereof. In one embodiment, aspects of the invention may be at least partially implemented with a computer and communication system, broadly referred to by the numeral 10 in FIG. 1. The system 10 may comprise one or more computing devices 14, 16 operated by a general practitioner (GP) veterinarian and/or a veterinarian specialist, various databases 18,20,22 accessible by the computing devices 14,16, and a communications network 24. The components of the computer and communication equipment 10 illustrated and described herein are merely examples of equipment that may be used to implement embodiments of the present invention and may be replaced with other equipment without departing from the scope of the present invention.

The computing devices 14,16 may be any of a conventional personal computer (PC), laptop, tablet (e.g., an iPad®), cellular phone, smartphone, personal digital assistant (PDA), and other computing devices configured to communicate over wired or wireless networks. The computing devices 14,16 may store and/or access data and other information that may be used by the GP veterinarian or veterinarian specialist to facilitate the exchange of diagnostic information. The computing devices 14,16 may implement one or more computer programs for performing some of the functions described herein and may communicate with each other and/or with the databases 18-22 via the communications network 24 or any other network.

In some embodiments of the invention, the computing devices 14,16 may include a first computing device 14 operated by the GP veterinarian and a second computing device 16 operated by the veterinarian specialist. Although only two computing devices 14,16 are shown in FIG. 1, it is understood that any number of such computing devices may interact with the system 10. For example, computing devices used by any of a plurality of veterinarian specialists and/or a plurality of GP veterinarians may be included in the system 10 and communicate with each other via the communications network 24.

The databases 18-22 may include any digital storage devices configured to store patient records, lists of veterinarian specialists, or other information required by the GP veterinarian and/or the veterinarian specialist. The databases 18-22 may also be configured to send and receive information to and from the computing devices 14,16 and/or other sources of information. For example, as later described herein, the GP veterinarian may access a veterinarian specialist database 18 remotely to identify an appropriate veterinarian specialist to consult on a particular case. In some embodiments of the invention, the first computing device 14 used by the GP veterinarian may be physically or wirelessly linked to communicate with a first internal database 20 of patient records specific to the GP veterinarian. Likewise, the second computing device 16 used by the veterinarian specialist may be physically or wirelessly linked to communicate with a second internal database 20 of patient records specific to the veterinarian specialist.

The communications network 24 may be a wired communications network, a wireless telecommunications network, or a combination thereof. The communications network 24 may be a telecommunications network, the Internet, or any other communications network such as a local area network, a wide area network, or an intranet. The communications network 24 may additionally or alternatively be any network capable of supporting wireless communications such as the wireless networks operated by AT&T, Verizon, or Sprint. The communications network 24 may include conventional switching and routing equipment. The communications network 24 may also be combined or implemented with several different networks.

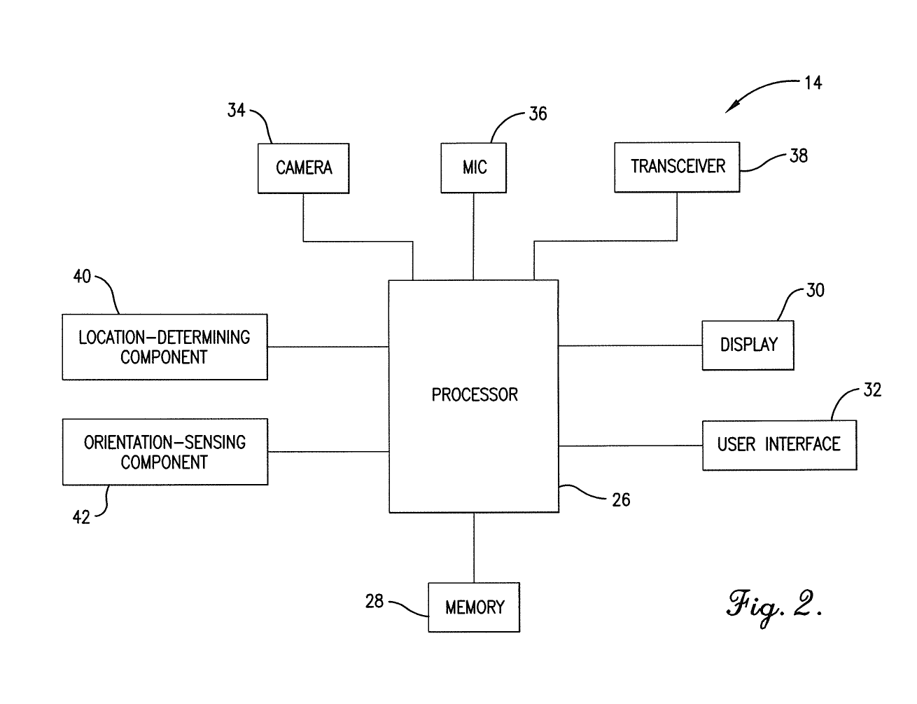

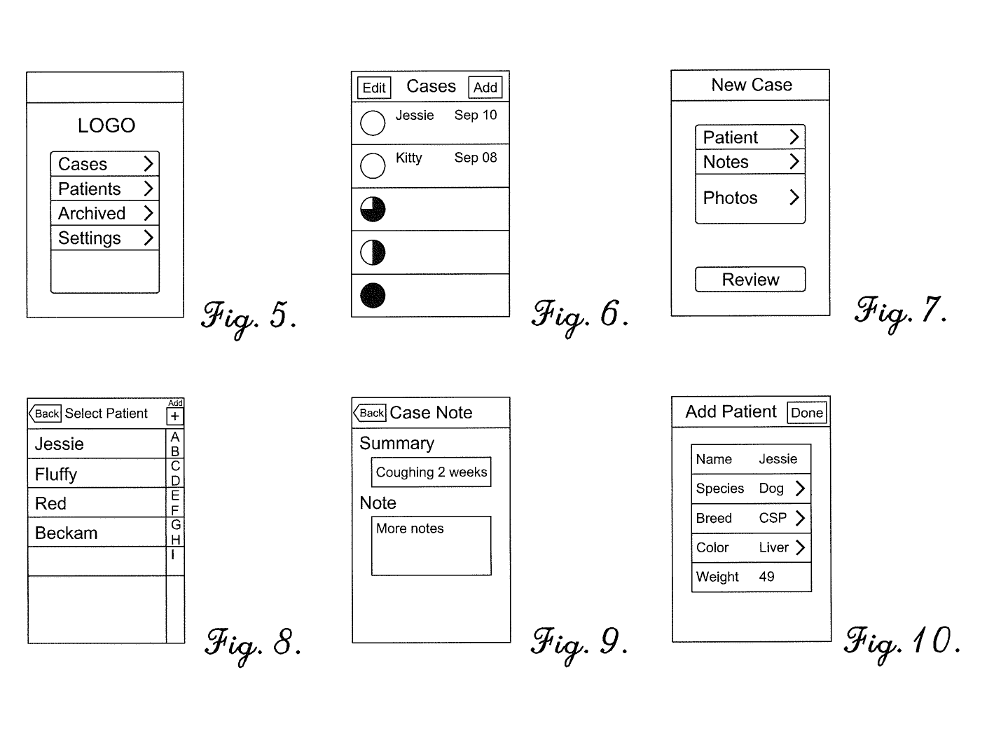

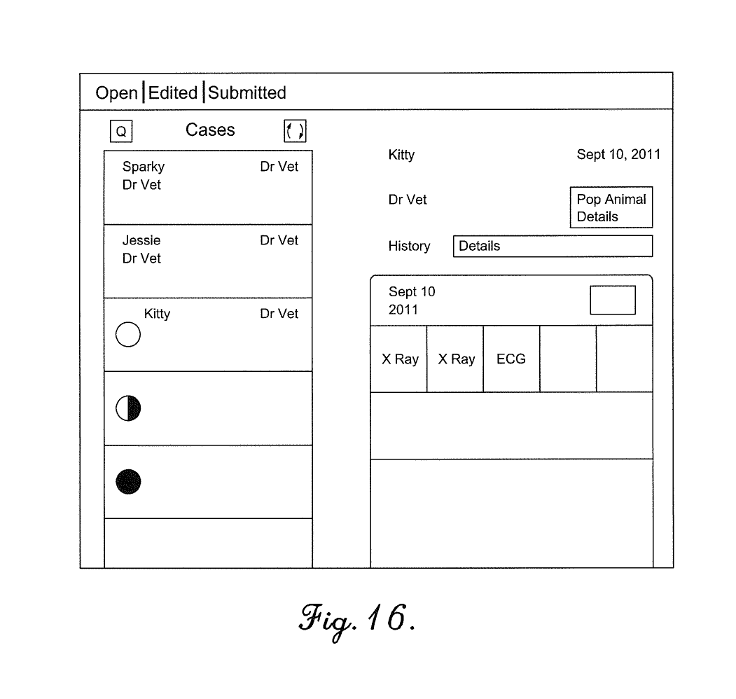

A block diagram of an example embodiment of one of the computing devices 14,16 is depicted in FIG. 2. Specifically, FIG. 2 illustrates the first computing device 14 comprising a processor 26, memory 28, a display 30, a user interface 32, a digital still and/or video camera 34, a microphone 36, a transceiver 38, a location-determining component 40, and/or an orientation-sensing component 42. Note that while only the first computing device 14 is depicted in FIG. 2, the second computing device 16 may also include any combination of the components described for the first computing device 14. Furthermore, different types of computing devices may be used by the GP veterinarians and the veterinarian specialists. For example, FIGS. 5-15 illustrate menus and display screens as they would be depicted on a smartphone display, while FIGS. 16-19 illustrate menus and display screens as they would be depicted on a tablet display.

The processor 26 may comprise any number and combination of controllers, circuits, integrated circuits, programmable logic devices such as programmable logic controllers (PLC) or motion programmable logic controllers (MPLC), computers, processors, microcontrollers, other electrical and computing devices, and/or other data and signal processing devices for carrying out the functions described herein, and may additionally comprise one or more memory storage devices (such as the memory 28), transmitters, receivers, and/or communication busses.

The processor 26 may be configured to implement any combination of the algorithms, subroutines, or code corresponding to method steps and functions described herein. The processor 26 and computer programs described herein are merely examples of computer equipment and programs that may be used to implement the present invention and may be replaced with or supplemented with other controllers and computer programs without departing from the scope of the present invention. While certain features are described as residing in the first computing device 14 or processor 26, the invention is not so limited, and those features may be implemented elsewhere. For example, databases accessed by the processor 26, such as the veterinarian specialist database 18, may be located remotely from the processor 26 and/or the memory 28 without departing from the scope of the invention.

In various embodiments of the invention, the processor 26 may implement a computer program and/or code segments to perform some of the functions described herein. The computer program may comprise an ordered listing of executable instructions for implementing logical functions in the first computing device 14. For example, the computer program may be a software program configured to run on a personal computer, laptop, or tablet, or the computer program may be a smartphone app configured to run on various mobile communications devices. The computer program can be embodied in any computer-readable medium for use by or in connection with an instruction execution system, apparatus, or device, and execute the instructions. In the context of this application, a “computer-readable medium” can be any means that can contain, store, communicate, propagate, or transport the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), a portable compact disk read-only memory (CDROM), an optical fiber, multi-media card (MMC), reduced-size multi-media card (RS MMC), secure digital (SD) cards such as microSD or miniSD, and a subscriber identity module (SIM) card.

Specifically, the computer program may be configured to run on one computing device or multiple computing devices, and may include code segments configured for creating or editing patient profiles, obtaining diagnostic imaging files and/or medical records, sending files, receiving files, searching one or more databases, annotating files, and/or associating files with each other. These code segments may be stored on the memory 28 of the first computing device 14, on multiple computing devices, and/or various servers and/or memory devices remotely accessible by the first computing device 14.

In some embodiments of the invention, two computer programs may be used, each including code segments for performing some or all of the method steps described herein. For example, one computer program may be configured to run on the first computing device 14 used by the GP veterinarian and another computer program may be configured to run on the second computing device 16 used by the veterinarian specialist. The two computer programs may be identical or may each comprise different portions of the computer program described herein and may be configured to communicate and/or interact with each other over a telecommunications network or other networks as described above.

The memory 28 may include one or more memory storage devices which may be integral with the processor 26, stand alone memory, or a combination of both. The memory may include, for example, removable and non removable memory elements such as RAM, ROM, flash, magnetic, optical, USB memory devices, MMC cards, RS MMC cards, SD cards such as microSD or miniSD, SIM cards, and/or other memory elements. Specifically, the memory may store at least a portion of the computer program or code segments described above, as well as user-specified preferences, information regarding user selections, medical records, diagnostic tools, etc.

The display 30 may comprise a graphical interface operable to display visual graphics, images, text, etc. in response to external or internal processes and commands. For example, the display 30 may comprise conventional black and white, monochrome, or color display elements including CRT, TFT, LCD, and/or LED display devices. The display 30 may be integrated with the user interface 32, such as in embodiments where the display 30 is a touch screen display to enable the user to interact with it by touching or pointing at display areas to provide information or selections to the processor 26. The display 30 may be coupled with or integral with the processor 26 and may be operable to display various information corresponding to the first computing device 14, its computer programs, statuses of operations performed thereby and data stored thereon, such as medical records, diagnostic images, instructions or requests from a veterinarian, an invoice, etc.

The user interface 32 may enable one or more users or veterinarians to exchange information and annotate diagnostic images, as later described herein. The user interface 32 may comprise one or more functionable inputs such as buttons, switches, scroll wheels, a touch screen associated with the display (as noted above), voice recognition elements such as a microphone, pointing devices such as mice, touchpads, tracking balls, styluses, cameras such as a digital still or video camera, combinations thereof, etc. Further, the user interface 32 may comprise wired or wireless data transfer elements such as a removable memory, data transceivers, etc., to enable the user and other devices or parties to remotely interface with the processor 26. The user interface 32 may also include a speaker for providing audible instructions and feedback.

The camera 34 may be any type of digital camera integral or communicably coupled with the processor 26 and/or memory 28, such as cameras built into smartphones, mobile phones, tablets, and the like. The camera may capture video or still images and/or echocardiography still pictures and loops. The video and/or images may be stored in the memory 28 prior to transmission thereof and/or may be transmitted via live streaming or real time to another device, with or without being recorded and stored in the memory 28. Additionally or alternatively, the camera 34 may include other diagnostic equipment or sensors without departing from the scope of the invention. For example, the camera 34 may be omitted and diagnostic images may be provided to the processor 26 by other diagnostic equipment communicably coupled with the processor 26 and/or memory 28. The other diagnostic equipment may include an X-ray machine, an EKG machine, an ultrasound machine, a MRI machine, or any known diagnostic equipment configured to output sensed test results, images, or graphical data. In some embodiments of the invention, the camera 34 and/or the processor 26 may support and conform to various DICOM classes (Digital Imaging and Communications in Medicine). DICOM is a file standard for handling, storing, printing, and transmitting information in medical imaging.

The microphone 36 may be any device configured to capture sound waves and may be communicably coupled with the processor 26 and/or the memory 28. The microphone 36 may be used to obtain spoken instructions or questions from a veterinarian and/or to record audio of the patient (e.g., the animal) for diagnostic purposes. For example, the microphone 36 may be configured to obtain audio from a stethoscope placed in contact with the patient.

A transceiver 38 may include any combination of transceivers, receivers, and/or transmitters configured for sending and receiving data, including text files, audio files, image files, or any type of digital data. In some embodiments of the invention, the transceiver 38 may also be communicably coupled with the location-determining component 40. Furthermore, in some embodiments of the invention where the first computing device 14 is a smartphone, the transceiver 38 may be used to send and receive telecommunication signals for phone calls and/or text messaging.

The location-determining component 40 may include a GPS receiver or any other location-determining sensors, such that the processor 26 may use its identified current geographic location to identify nearby veterinarians or other specialists. The orientation-sensing component 42 may be an accelerometer, tilt sensor, inclinometer, or any orientation-sensing component configured to communicate with the processor 26 about the orientation of the first computing device 14 and/or the display 30. The orientation-sensing component 42 may output information to allow the processor 26 to provide properly-oriented information and images to the display 30.

In one embodiment of the invention, a method of facilitating an exchange of diagnostic and other information between a GP veterinarian and a veterinarian specialist broadly includes creating and/or receiving the file or files corresponding to a patient, identifying a veterinarian specialist from a database of a plurality of veterinarian specialists based on input from the GP veterinarian, and sending the file to the veterinarian specialist. The patient may be an animal of any type generally seen by a veterinarian. In this embodiment of the invention, the method may also comprise receiving information from the veterinarian specialist regarding a review of the file by the veterinarian specialist.

An additional or alternative method of the present invention may comprise receiving at least one file comprising medical information corresponding to a patient or patients of the GP veterinarian, permitting the veterinarian specialist to annotate the file, and then sending the file with annotations from the veterinarian specialist to the GP veterinarian so that the GP veterinarian can use the annotated file to treat the patient.

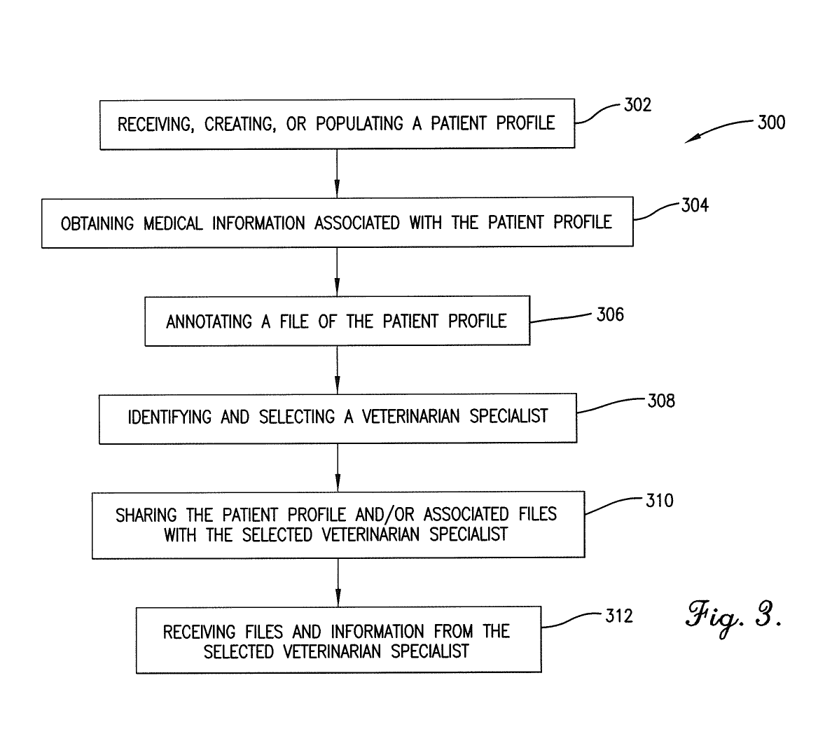

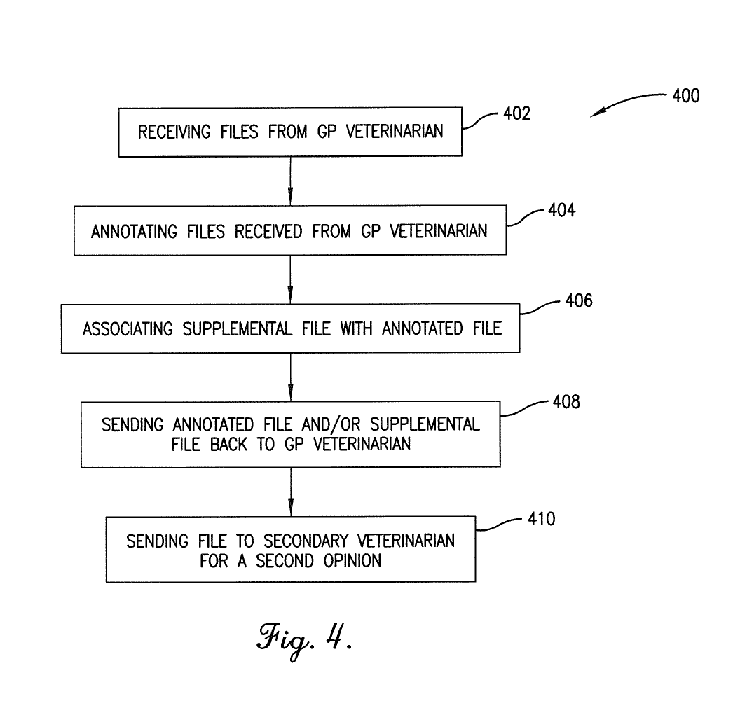

The flow charts of FIGS. 3 and 4 show the functionality and operation of exemplary implementations of the present invention in more detail. In this regard, some of the blocks of the flow chart may represent a module segment or portion of code of the computer programs of the present invention. The computer programs may comprise one or more executable instructions for implementing the specified logical function or functions. In some alternative implementations, the functions noted in the various blocks may occur out of the order depicted in FIGS. 3 and 4. For example, two blocks shown in succession in FIG. 3 or 4 may in fact be executed substantially concurrently, or the blocks may sometimes be executed in the reverse order depending upon the functionality involved. Some of the module segments or code of the computer programs may display, populate, or otherwise enable the screen displays shown in FIGS. 5-25.

A method 300, as illustrated in FIG. 3, may include a step of receiving, creating, or populating a patient profile for a patient, as depicted in block 302 and illustrated in FIGS. 5-14. For example, the computer program may display selectable menu options and instructions for creating patient profiles. Specifically, the GP veterinarian may select an option labeled “cases” on the main menu illustrated in FIG. 5, which may prompt the computer program to display the menu illustrated in FIG. 6. Then the GP veterinarian may be allowed to select an “edit” or an “add” button on a touch screen of the first computing device 14 to begin populating a patient profile, as illustrated in FIG. 6. Various graphics, such as a fillable circle or pie chart, may be provided to indicate a level of completion of a patient profile or case profile, as illustrated in FIG. 6. For example, the computer program may require a pre-determined quantity or type of files be associated with a case or approval by particular individuals before indicating that a patient profile or case is complete.

The GP veterinarian may be presented with a series of options, drop-down menus, and/or fillable text boxes to either narrow search parameters for locating a current patient profile, as illustrated in FIG. 8, or to provide information about a new patient, as illustrated in FIGS. 7 and 10. For example, the options, drop-down menus, and/or fillable text boxes may request information about a patient's name, breed, weight, color, age, birthday, species, and medical history. The GP veterinarian may enter information about the patient and/or the medical condition of the patient as provided by the owner or caregiver of the patient via the user interface 32, as illustrated in FIGS. 9 and 10. Additionally or alternatively, the patient profile may be obtained from a database or various medical records accessible by the GP veterinarian.

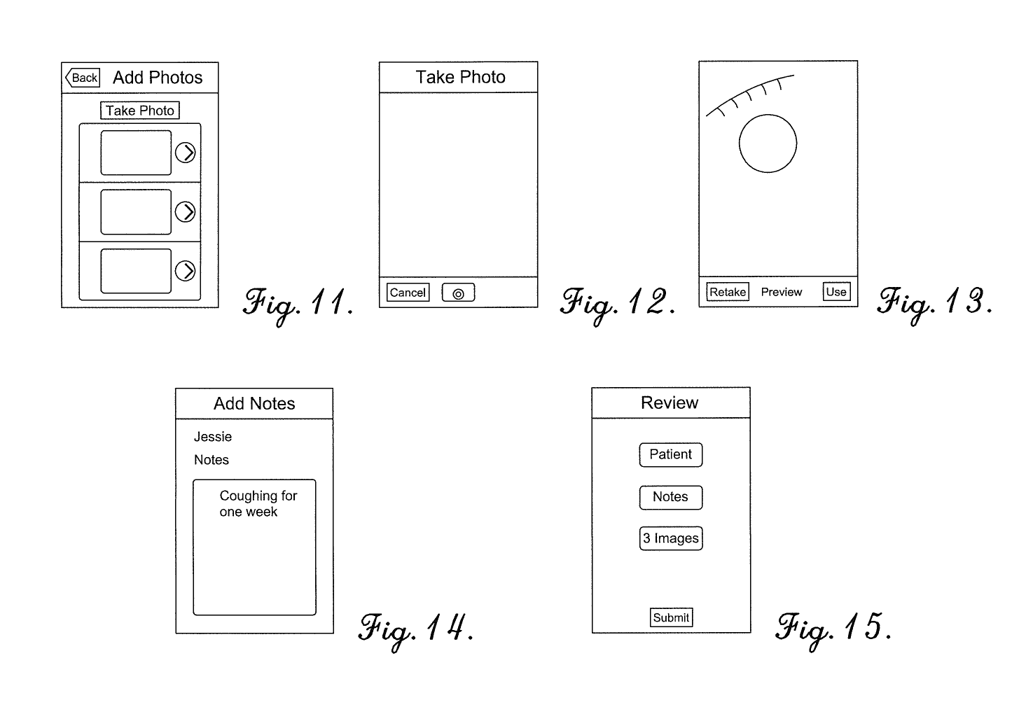

Next, the method 300 may comprise obtaining a diagnostic imaging file or medical records, as depicted in block 304. This may include searching for a particular image file or medical records based on search information input by the GP veterinarian or any user of the first computing device 14. For example, the GP veterinarian may take a picture with the camera 34 of the patient, as illustrated in FIGS. 11-13, and save the picture in a particular location on the memory 28 of the first computing device 14. The GP veterinarian may then use drop-down menus or search features of the computer program to locate the picture and attach it to or otherwise associate it with a corresponding patient profile. Alternatively, other diagnostic images and medical records stored on external devices or in external databases may be uploaded to the first computing device 14 or accessed by the first computing device 14. As illustrated in FIG. 14, notes may be added and/or attached to specific diagnostic images associated with a particular patient or case.

Note that the file or image file, as described herein, may include one or more files having one or more file formats, such as .JPG, .PDF, .DOC, .DCM (or other DICOM-related file formats), etc. Furthermore, the file may include one or more images, such as a picture taken with the camera 34 or obtained via diagnostic equipment, such as an x-ray, EKG, ECG, sonogram, CT (catscan), MRI, and the like. The file may also include video (pre-recorded and/or live streaming), audio, and/or 3D images or models. The file may also include data regarding services requested by the GP veterinarian to be rendered by the veterinarian specialist, information about the GP veterinarian, etc. For example, the file may include an image file (e.g., an animal's ECG), the patient's profile, any medical history on the animal, and text or audio instructions, requests, or questions from the GP veterinarian to the veterinarian specialist. In another example embodiment of the invention, the GP veterinarian may participate in a live video chat with the veterinarian specialist and/or may perform an echocardiogram live while the veterinarian specialist watches via streaming video.

In some embodiments of the invention, the method 300 may include a step of annotating the file before sending it to the veterinarian specialist, as depicted in step 306. Annotating the file may comprise circling or highlighting items of concern and including questions to the veterinarian specialist in a comments section.

Once the file to be sent is identified, the method 300 may comprise a step of identifying and selecting a veterinarian specialist, as depicted in block 308. This step may comprise searching one or more databases to identify an appropriate veterinarian specialist for a particular patient or a medical issue associated with that patient. The veterinarian specialist may be selected by the GP veterinarian from a plurality of veterinarian specialists listed in the veterinarian specialist database 18 or any other appropriate databases. The searching step may include the first computing device 14 receiving relevant information about the particular patient from the GP veterinarian. Furthermore, in some embodiments of the invention, searching the database may include obtaining a geographic location of the first computing device 14 via the location-determining component 40 and listing appropriate veterinarian specialists according to their geographic location relative to the first computing device 14 of the GP veterinarian.

For example, the computer program may be configured to display options, drop-down menus, and/or text boxes on the display 30 and prompt the user or GP veterinarian to enter parameters for identifying a veterinarian specialist. The computer program may then use these parameters to locate and display a plurality of applicable veterinarian specialists. The computer program may also receive a selection from the user or GP veterinarian regarding which veterinarian specialist he or she would like to review the patient's profile, image file, and other relevant information.

Next, the method 300 may comprise a step of sharing the patient profile and/or associated files, as depicted in block 310. Specifically, the computer program may digitally transmit and/or upload at least one file, such as the patient's profile or the image file, to another computing device (e.g., the second computing device 16) and/or a server accessible by at least one other individual located remotely from the first computing device 14. For example, the computer program may present the GP veterinarian or veterinarian specialist with a “submit” button on the display 30, as illustrated in FIG. 15, and selection of this button may send the file or files, including the patient profile, medical history, the image file, instructions, requests, questions, and/or other associated data to the one or more veterinarian specialists or other GP veterinarians selected by the GP veterinarian.

Finally, the method may comprise a step of receiving files and information from the veterinarian specialist regarding a review of the file by the veterinarian specialist, as depicted in block 312. This step may involve the first computing device 14 accepting or downloading files and notifying the GP veterinarian that another individual has elected to share files with them or send files to them. The files received by the first computing device 14 of the veterinarian may include annotated files, invoices, and any other files relevant to a particular case or patient.

In other embodiments of the invention, a method 400, illustrated in FIG. 4, may begin with a step of receiving files from the GP veterinarian, as depicted in block 402. For example, the file or files may be accepted or downloaded by the second computing device 16, which may then notify the veterinarian specialist that another individual has elected to share files with them or send files to them. The computer program may be configured to command the second computing device 16 to output a visual and/or audible notification when particular files are received, such that the veterinarian specialist knows to open and review the received files.

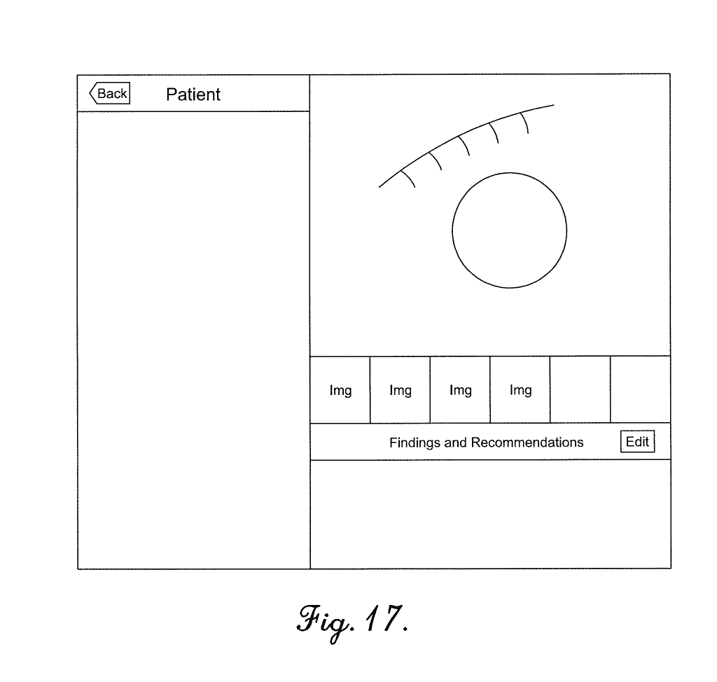

Next, the method 400 may comprise annotating the file or files, as depicted in block 404. Annotating the file or files may involve making various measurements and adding text or markings to some or all of the files. FIGS. 16 and 17 illustrate example menus displayed on the second computing device 16 listing files or cases received from the GP veterinarian and/or other sources which may be selected by the veterinarian specialist to begin viewing and/or annotating the files. In some embodiments of the invention, as illustrated in FIG. 16, various graphics, such as a fillable circle or pie chart, may be provided to indicate whether all files necessary for review have been received by the second computing device 16. Furthermore, summaries of various files and/or their content may be provided on the menus, as illustrated in FIGS. 16 and 17.

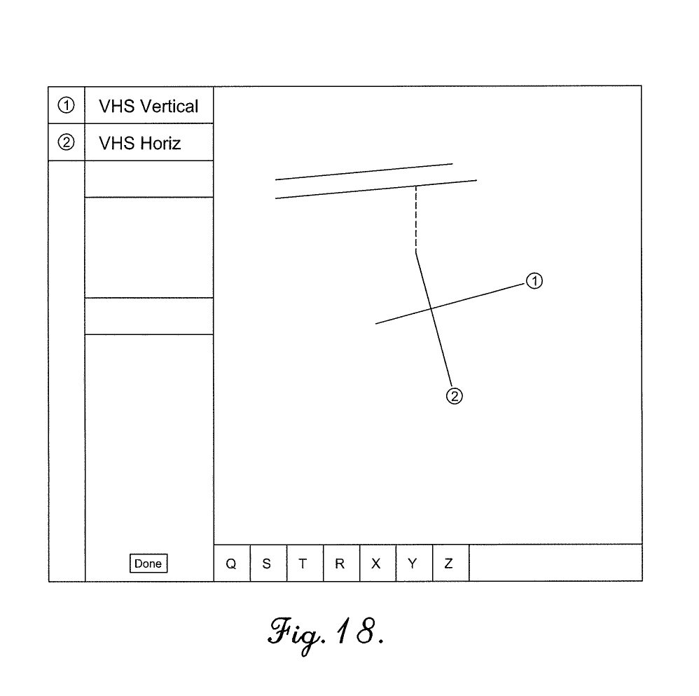

The computer program may present a variety of drawing and text tools, as illustrated in FIG. 18, to allow the veterinarian specialist to mark one or more of the files, such as the image file. For example, the computer program may provide a menu of software annotating tools to be selected by the user of the second computing device 16. The tools may include tools for free-hand drawing, drawing lines, drawing parallel lines, drawing perpendicular lines, drawing circles, drawing arrows, highlighting portions of the image, adding text, or applying any graphics to the file or image. The graphics applied to the file with the tools may overlay any text or images of the original file, as illustrated in FIGS. 20-26. The drawing tools may also include various manipulation capabilities, such as stretching or reorienting a particular graphic applied to the image or file.

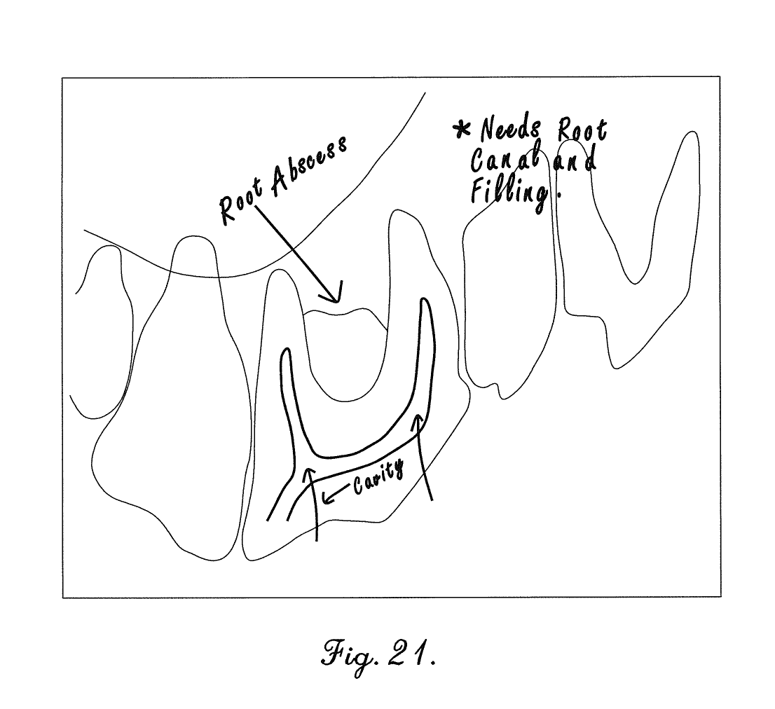

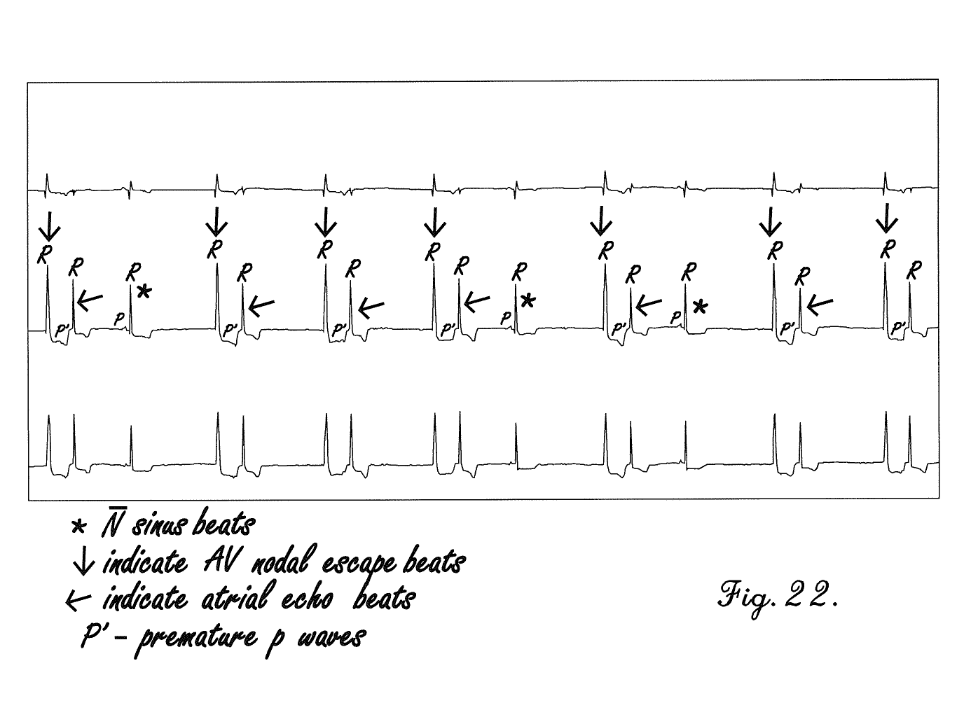

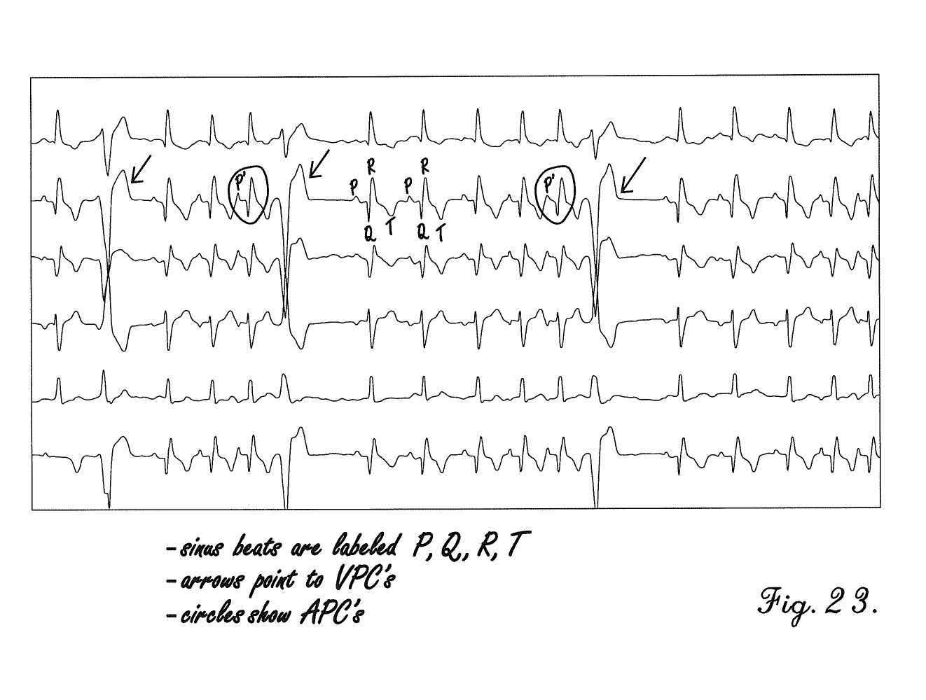

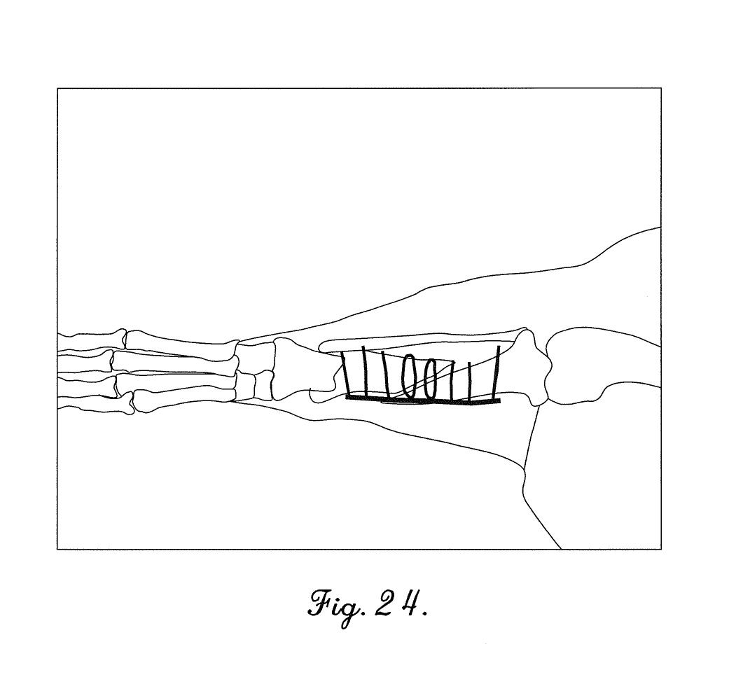

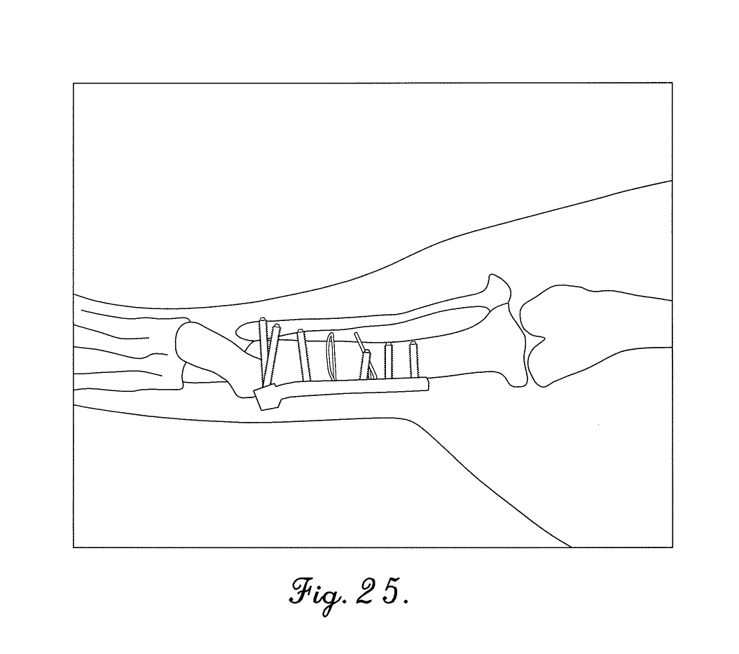

For example, the file or image may be cardiological in nature, such as an X-ray image by which measurements may be made to determine the patient or animal's vertebral heart score (VHS), as illustrated in FIGS. 18 and 20. Specifically, the veterinarian specialist may draw lines on the X-ray image to annotate the VHS and label vertebrae, as illustrated in FIG. 20. In another example, the veterinarian specialist may annotate an ECG graph, as illustrated in FIGS. 22 and 23, indicating P waves and T waves, circling relevant parts of the graph and annotating atrial echo beats. The file may also include dental x-rays, as illustrated in FIG. 21, or x-rays of fractured bones, as illustrated in FIGS. 24 and 25.

In some embodiments of the invention, the veterinarian specialist may be provided with tools for realigning fractures and adding graphical depictions of plates, screws, circlage wires, and other items for holding the fractured bones in place, as illustrated in FIGS. 24 and 25. The plates may be stretched or manipulated and the annotation may include information regarding which side of the bone with how many screws to use and other information required for setting the bone.

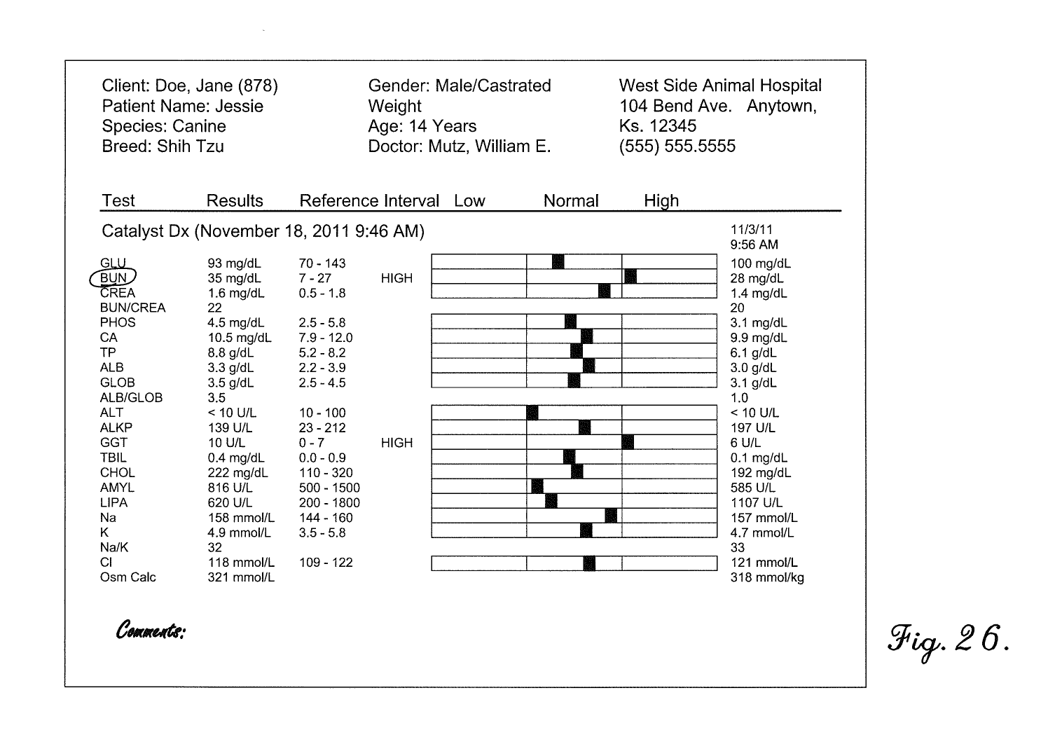

The file may also comprise documents or image files of documents with test results listed thereon, as illustrated in FIG. 26. The veterinarian specialist may annotate the test results by adding text in a comment section provided thereon and/or by circling or highlighting particularly relevant information. Annotating the files may also comprise resizing any of the files according to user input using various zoom features provided by the computer program. Furthermore, annotating the file may comprise panning to different locations on any of the files and/or reorienting the files displayed on the second computing device 16.

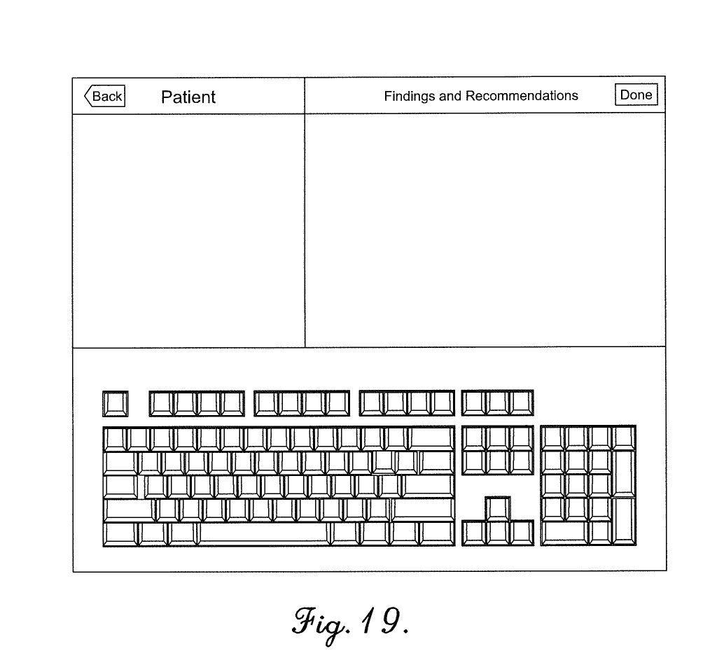

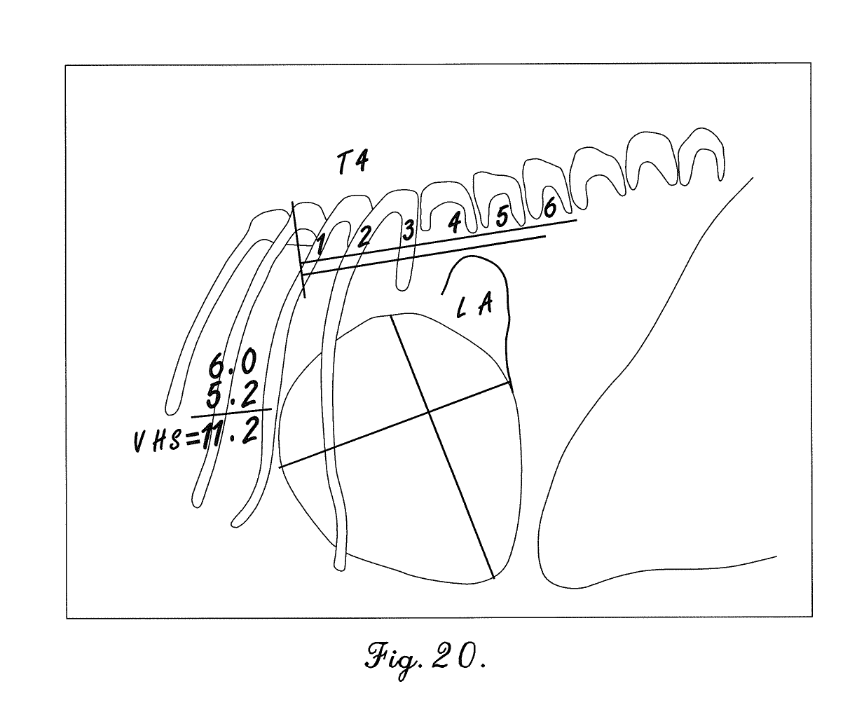

Next, the method 400 may comprise a step of attaching a supplemental file to or associating the supplemental file with the annotated file, as depicted in step 406. For example, the supplemental file may include additional medical information related to the file, the patient, or a particular medical condition. Additionally or alternatively, the supplemental file may include a medical diagnosis and/or an invoice for the GP veterinarian. As illustrated in FIG. 19, the computer program may provide a keyboard or other input tools to the veterinarian specialist for adding their findings and recommendations to the file. In some embodiments of the invention, the invoice may be generated automatically depending on the amount of time spent on the review or other pre-determined criteria. For example, the invoice may be created or adjusted by selecting from a plurality of selectable menu items on the display 16. The method may further comprise automatically charging a particular account or credit card according to the invoice.

The method 400 may further comprise a step of sending the annotated file and/or the supplemental file back to the referring GP veterinarian, as depicted in block 408. For example, the file may be sent directly to the first computing device 14 of the GP veterinarian and/or uploaded to a shared database accessible by the GP veterinarian, such as a database comprising medical records of the GP veterinarian's patients. The supplemental file may be sent to the GP veterinarian in a similar manner.

Additionally or alternatively, the method 400 may comprise a step of sending the file with annotations or without annotations to a secondary veterinarian specialist for a second opinion, as depicted in block 410. The veterinarian specialist may select the secondary veterinarian specialist in a similar manner to the method described above in method 300. Furthermore, the veterinarian specialist may attach or associate various supplemental files with the file to be sent to the secondary veterinarian specialist. The supplemental files submitted to the secondary veterinarian specialist may be different than the supplemental file sent back to the GP veterinarian. The secondary veterinarian specialist may send results of their review back to the original veterinarian specialist and/or to the GP veterinarian using any method described herein.

Although the invention has been described with reference to the embodiments illustrated in the attached drawing figures, it is noted that equivalents may be employed and substitutions made herein without departing from the scope of the invention as recited in the claims. For example, the steps performed on the first computing device 14 may be performed on the second computing device 16 and vice versa. Additionally, the method steps performed by the GP veterinarian may be performed by the veterinarian specialist and vice versa. Note that at least some of the method steps performed herein may also be performed by individuals other than the GP veterinarian and the veterinarian specialist. For example, a vet tech or other medical professionals may use the computer program described herein without departing from the scope of the invention.

Having thus described various embodiments of the invention, what is claimed as new and desired to be protected by Letters Patent includes the following:

1. A non-transitory computer readable medium having a computer program stored thereon for operating a computer system to facilitate an exchange of information between a general practitioner veterinarian and a veterinarian specialist, the computer program comprising:
a code segment for receiving from an electronic device operated by the general practitioner at least one file comprising medical information corresponding to at least one patient of the general practitioner veterinarian;
a code segment for identifying the veterinarian specialist from a database of a plurality of veterinarian specialists based on input from the general practitioner veterinarian;
a code segment for sending at least portions of the file to an electronic device operated by the veterinarian specialist;
a code segment for permitting the veterinarian specialist to annotate the file; and
a code segment for sending the file with annotations from the veterinarian specialist to the electronic device operated by the general practitioner veterinarian so that the general practitioner veterinarian can use the file with the annotations to treat the patient.

2. The non-transitory computer readable medium of claim 1, wherein the code segment for sending the file with annotations comprises uploading the file to a database comprising medical records corresponding to the general practitioner veterinarian.

3. The non-transitory computer readable medium of claim 1, wherein the file includes information regarding at least one of the patient's name, breed, weight, color, age, birthday, species, and medical history.

4. The non-transitory computer readable medium of claim 1, wherein the file includes an image.

5. The non-transitory computer readable medium of claim 4, wherein the image is at least one of a digital photograph, an X-ray image, and other images or graphs obtained by one or more medical scans or tests.

6. The non-transitory computer readable medium of claim 1, wherein the file includes data regarding services requested by the general practitioner veterinarian to be rendered by the veterinarian specialist.

7. The non-transitory computer readable medium of claim 4, wherein the code segment for permitting the veterinarian specialist to annotate the file includes a code segment for placing graphical images, lines, shapes, or text onto the image based on input or selections made by the veterinarian specialist.

8. The non-transitory computer readable medium of claim 1, wherein the computer program further comprising a code segment for associating a supplemental file with the file, wherein the supplemental file includes at least one of additional medical information related to the file, a medical diagnosis, and an invoice.

9. The non-transitory computer readable medium of claim 8, wherein the computer program further comprises a code segment for sending the supplemental file to the general practitioner veterinarian.

10. The non-transitory computer readable medium of claim 4, wherein the computer program further comprises a code segment for resizing the image based on input or selections made by the veterinarian specialist.

11. The non-transitory computer readable medium of claim 1, wherein the computer program further comprises a code segment for sending an invoice to the general practitioner veterinarian based on input from or selections made by the veterinarian specialist.

12. The non-transitory computer readable medium of claim 1, wherein the computer program further comprises a code segment for sending the file with annotations or without annotations to a secondary veterinarian specialist for a second opinion.

13. (canceled)

14. (canceled)

15. (canceled)

16. (canceled)

17. (canceled)

18. (canceled)

19. A non-transitory computer readable medium having computer programs stored thereon for operating electronic devices to facilitate an exchange of information between a general practitioner veterinarian and a veterinarian specialist, the computer programs comprising:
a code segment for obtaining, with an electronic device operated by the general practitioner, at least one file comprising medical information corresponding to at least one patient of the general practitioner veterinarian;
a code segment for identifying the veterinarian specialist from a database of a plurality of veterinarian specialists based on input from the general practitioner veterinarian;
a code segment for sending the file from the electronic device operated by the general practitioner to an electronic device operated by the veterinarian specialist;
a code segment for annotating the file with the electronic device operated by the veterinarian specialist according to input or selections made by the veterinarian specialist;
a code segment for associating a supplemental file with the file, wherein the supplemental file includes at least one of additional medical information related to the file, a medical diagnosis, and an invoice;
a code segment for sending the file with annotations and the supplemental file from the electronic device operated by the veterinarian specialist to the electronic device operated by the general practitioner veterinarian.

20. The non-transitory computer readable medium of claim 19, wherein the file includes an image, wherein the image is at least one of a digital photograph, an X-ray image, and other images or graphs obtained by one or more medical scans or tests, wherein the code segment for annotating the file includes a code segment for placing graphical images, lines, shapes, or text onto the image based on the input or selections made by the veterinarian specialist.

21. Computer programs stored on non-transitory computer readable medium for facilitating exchange of information between a general practitioner veterinarian and a veterinarian specialist, the computer programs comprising:
a computer program for operating an electronic device operated by the general practitioner, the computer program comprising—
a code segment for obtaining at least one file comprising medical information corresponding to at least one patient of the general practitioner veterinarian;
a code segment for identifying the veterinarian specialist from a database of a plurality of veterinarian specialists based on input from the general practitioner veterinarian;
a code segment for transmitting the file from the electronic device operated by the general practitioner; and
a computer program for operating an electronic device operated by the veterinarian specialist, the computer program comprising—
a code segment for receiving the file transmitted from the electronic device operated by the general practitioner;
a code segment for annotating the file according to input or selections made by the veterinarian specialist;
a code segment for associating a supplemental file with the file, wherein the supplemental file includes at least one of additional medical information related to the file, a medical diagnosis, and an invoice;
a code segment for sending the file with annotations and the supplemental file from the electronic device operated by the veterinarian specialist to the electronic device operated by the general practitioner veterinarian.
